(19) United States
(12) Patent Application Publication
(10) Pub. No.: US 2023/0363079 A1
(43) Pub. Date: Nov. 9, 2023

(54) MODIFIED CATHODE DEVICE AND HOLDER ASSEMBLY FOR PLASMA ARC SPRAY GUN

(71) Applicant: PRAXAIR S.T. TECHNOLOGY, INC., North Haven, CT (US)

(72) Inventor: David A. Somerville, Salisbury, NH (US)

(21) Appl. No.: 17/777,420

(22) PCT Filed: Mar. 4, 2021
(86) PCT No.: PCT/US2021/020845

§ 371 Date: May 17, 2022

Related U.S. Application Data
(60) Provisional application No. 62/985,983, filed on Mar. 6, 2020.

(51) Int. Cl. H05H 1/42; H05H 1/34; H05H 1/38

(52) U.S. Cl. CPC H05H 1/42; H05H 1/3447; H05H 1/38

(57) ABSTRACT

A novel, modified cathode device having partially dome shaped portion with a cathode flat surface therealong has been created, whereby arc rotational movement is significantly improved over conventional cathode designs. A complimentary cathode holder with enhanced cooling features is provided to prevent overheating of the cathode tip. The end result is an improved, more versatile plasma arc spray gun that can run at elevated power and enthalpy levels without incurring thermal damage.

### RELATED APPLICATIONS

This application claims the benefit of priority to International Application No. PCT/US2021/020845, filed on Mar. 4, 2021, which claimed the benefit of priority to U.S. Provisional Application Ser. No. 62/985,983, filed on Mar. 6, 2020, which are incorporated herein by reference in its entirety for all purposes.

### FIELD OF THE INVENTION

The present invention relates to a novel cathode design with certain geometric attributes that lead to more uniform movement of the plasma arc within the anode during a coating operation.

### BACKGROUND OF THE INVENTION

Plasma-arc spray guns, as shown in FIG. 1, are typically used to create a molten powder that is deposited onto a substate. The gun uses a power supply and a cathode disposed within an anode. A potential difference is applied between the cathode and anode to generate an arc for use in depositing a material onto a substrate. A plasma gas is supplied to the chamber between the anode and the cathode. The plasma gas converts to a high-temperature plasma as it passes through the arc that extends between the anode and cathode. To provide for a stable and controllable plasma, it is important to control the location and length of the arc between the anode and cathode as well as the rotational movement of the arc along the anode inner surface.

Today, plasma arc spraying is desired to be performed at higher enthalpies and higher power levels. However, current plasma spray conditions with higher enthalpy and higher power levels pose operational challenges. The large currents of electricity flowing between the anode and the cathode cause the cathode tip to heat significantly, thereby causing the cathode to potentially crack, spall and/or chip. As a result, the cathode is susceptible to surface imperfections. The defects of the cathode cause the arc to remain substantially stationary and stop its rotational movement. As a result, the performance and operating life of the plasma spray arc gun can be significantly reduced. Additionally, the higher enthalpy and higher power levels lead to excessive heating of the plasma spray arc gun, despite the water cooling employed as shown in FIG. 1. Still further, the portions of the cathode that spall and/or chip can become entrained in the plasma effluent (i.e., molten powder entrained with plasma gas), and ultimately create contamination in the resultant coating that is deposited onto a substrate.

Given the performance, durability and stability challenges with current plasma spray arc guns, there remains an unmet need for improved plasma arc spray guns that are capable of operating at elevated enthalpy and power levels without damage.

### SUMMARY OF THE INVENTION

In one aspect, a modified cathode device adapted for use in a plasma arc spray gun, said modified cathode device comprising: a central longitudinal axis traversing the modified cathode device from a first end to a second end; a partially dome-shaped portion, said partially dome-shaped portion having rounded edges, said rounded edges terminating as a flat surface along the first end of the modified cathode device, said flat surface characterized by a width extending from a first edge of the flat surface to a second edge of the flat surface and a midpoint located between the first edge and the second edge, wherein the midpoint of the flat surface is located along the central longitudinal axis of the modified cathode device; and a body portion extending from the partially dome-shaped body portion to the second end of the modified cathode device.

In a second aspect, an improved cathode assembly for use in a plasma arc spray gun, comprising: a modified cathode device having a partially dome-shaped portion along a first end and a body portion extending from the partially dome-shaped portion to a second end of the modified cathode device, a cathode holder having an inner surface configured for receiving the body portion of the modified cathode device at the second end thereof, said cathode holder comprising a cooling water enhancement, said cooling water enhancement configured to be in direct contact with the second end of the body portion of the modified cathode device; wherein the partially dome-shaped portion is located external to the cathode holder; and further wherein each of the modified cathode device and the cathode holder is coaxial with a central longitudinal axis that traverses the improved cathode assembly.

In a third aspect, an improved plasma arc spray gun, comprising: a modified cathode device having a partially dome-shaped portion along a first end and a body portion extending from the partially dome-shaped portion to a second end of the modified cathode device, a cathode holder having an inner surface operably connected to the body portion of the modified cathode device at the second end thereof to form an improved cathode assembly, said cathode holder comprising a cooling water enhancement, said cooling water enhancement configured to be in direct contact with the second end of the body portion of the modified cathode device; wherein the partially dome-shaped portion is located external to the cathode holder; an anode having an exterior and an interior, the anode interior defined by a first interior segment, a second interior segment, and a third interior segment, the first interior segment in fluid communication with a powder injection pathway, the second interior segment containing the modified cathode device and the third interior section containing the cooling water enhancement of the cathode holder; wherein the improved cathode assembly and the anode are coaxial with a with a central longitudinal axis that traverses the improved plasma arc spray gun.

### BRIEF DESCRIPTION OF THE DRAWINGS

FIG. 1 is a representative schematic of a conventional plasma spray arc gun;

FIG. 2a is a representative schematic of a new cathode design in accordance with the principle of the present invention;

FIG. 2b is a representative end view of the new cathode design of FIG. 2a in accordance with the principle of the present invention;

FIG. 2c is a representative perspective view of the new cathode design of FIGS. 2a and 2b in accordance with the principles of the present invention;

FIG. 3a is a representative cross-sectional schematic of a new cathode holder for the new cathode design of FIG. 2a in accordance with the principle of the present invention;

FIG. 3b is a representative end view of the new cathode holder of FIG. 3a in accordance with the principle of the present invention;

FIG. 3c is a representative perspective view of the new cathode holder of FIGS. 3a and 3b in accordance with the principle of the present invention;

FIG. 4 is a representative side view of a new cathode design loaded within a new cathode holder, in accordance with the principles of the present invention;

FIG. 5 is a representative schematic of the new cathode device and the new cathode holder as part of an improved plasma spray arc gun, in accordance with the principles of the present invention; and

FIG. 6 shows a photograph of a damaged cathode tip having a fully dome shaped portion with no flat surface that was evaluated by Applicants before arriving at the design of the present invention;

FIG. 7 shows a photograph of a cathode tip having a fully dome shaped portion with no flat surface and with no longitudinal taper that was evaluated by Applicants before arriving at the design of the present invention;

FIG. 8 shows a photograph of a cathode tip having a partial dome tip shape with a flat surface that was evaluated by Applicants; and

FIG. 9 shows a photograph of the cathode tip design of FIG. 8 after performing extensive testing, indicating the absence of damage.

### DETAILED DESCRIPTION OF THE INVENTION

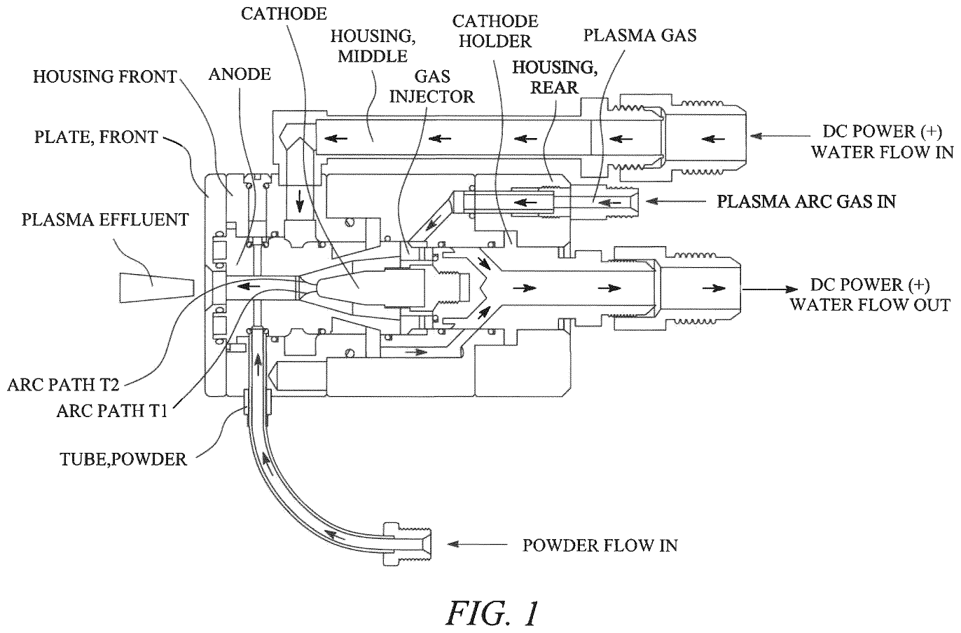

Applicants have surprisingly discovered that modifications to the existing cathode shape and cathode holder as shown in FIG. 1 can result in significant reduction in cathode damage, thereby extending the life of the cathode and accompanying plasma arc spray gun into which it is installed. The plasma spray arc guns, cathodes, and cathode holders disclosed herein may comprise, consist, or consist essentially of any of the specific components and structures illustratively described herein. The disclosure further contemplates restrictively defined plasma spray arc guns, cathodes, and cathode holders, e.g., wherein one or more of the specifically described parts, components, and structures may be specifically omitted, in defining operative embodiments of the present disclosure.

The present invention recognizes shortcomings of existing plasma spray arc guns, such as those shown in FIG. 1. For example, the Applicants have observed that excess heat loading on the cathode surface along the tip can result in surface imperfections, such as spalling and chipping. The surface imperfections on the cathode surface can result in the arc path (as shown in FIG. 1) becoming irregular and/or the arc becoming stationary instead of desirably moving in a sweeping and uniform manner between the cathode and anode.

FIG. 1 shows an arc extending between the cathode rounded edges and the anode. The arc is created by applying a voltage potential between the positive and negative potential leads. The arc is created within the gap between the cathode tip and anode inner surface. Two arcs between the cathode tip and anode are shown in FIG. 1. Each of the two arcs is intended to show a first location of the arc at time t1, and a second location of the arc at time t2. One end of the arc moves along the tip of the cathode and the other end of the arc moves along the inner surface of the anode. However, during the coating operation, Applicants observed that the arc rotational movement within the anode inner surface becomes irregular, whereby the arc momentarily stops rotating or permanently stops rotating thereby remaining stationary at a certain location at the anode inner surface. As such, the arc end at the anode inner surface can partially or entirely cease rotational movement. Additionally, the length of the arc between the cathode tip and anode surface can change during the coating observation as a result of the end point of arc attachment at the cathode tip continuously or intermittently changing during the coating operation. The irregular arc rotational movement of FIG. 1 causes non-uniform distribution of heat. The excess heat on the cathode tip generates surface defects therealong that can further increase the tendency for the arc to undergo a significant reduction in rotational movement or entirely cease rotational movement. Accordingly, the design of FIG. 1 can lead to the arc remaining at a single point of attachment along the anode inner surface, which is detrimental to the life of the anode. The failure of the arc to rotate will concentrate excess heat along the anode as well as the cathode, which results in surface defects. It is believed that the surface defects in the cathode causes further disruption to the arc rotational movement. In this manner, excess heat tends to accumulate along the cathode tip as observed by Applicants, and the cathode can eventually become thermally damaged over time. Spalling or chipping can cause fragmented pieces from the cathode to become deposited into the plasma effluent, which can end up in the resultant coating.

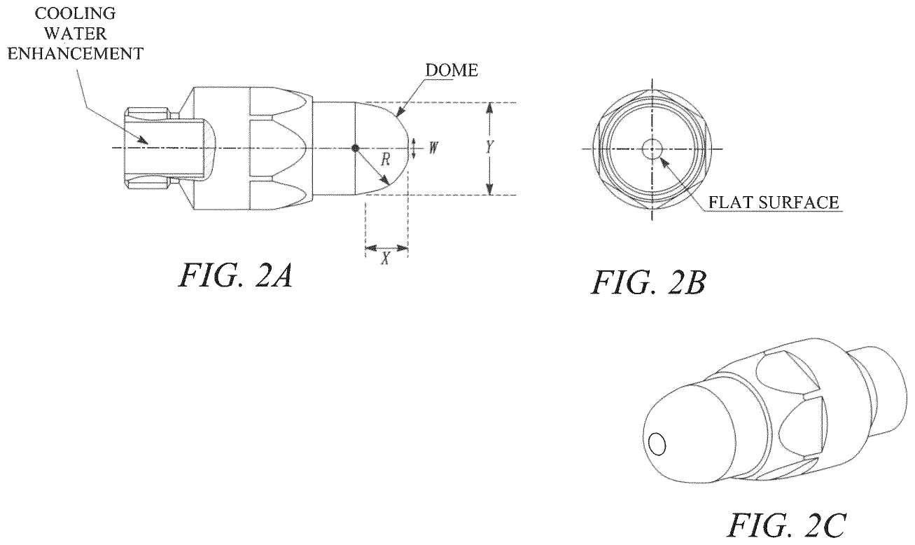

From these shortcomings of the apparatus of FIG. 1 as observed by Applicants, the present invention has emerged. FIG. 2a is a representative cross-sectional schematic of a new modified cathode design in accordance with the principles of the present invention. The cathode device has a partially dome shaped end portion. The partially dome shaped end portion has rounded edges that terminate or converge as a flat surface along a tip of the cathode device. A central longitudinal axis traverses the flat surface such that a midpoint of the flat surface is located along the central longitudinal axis. The flat surface can be characterized by a width (designated as “W” in FIG. 2A) that can be defined as extending between a first edge and as second edge. Each of the first edge and second edge is spaced apart from the central longitudinal axis by the same distance. Any suitable W to facilitate arc attachment along the cathode tip is contemplated. In one example, W can range from 0.05 inches to about 0.15 inches and more preferably 0.075 inches to 0.125 inches. The cathode further includes a body portion that extends from the partially dome-shaped end portion.

Applicants have surprisingly discovered that the flat surface creates a stable point of attachment for an end portion of the arc to attach thereto. The other end of the arc extends toward an inner surface of the anode. On the contrary, the fully rounded tip of FIG. 1 without a flat on it does not fixate the arc to the center portion of the cathode, thereby leading to the problems described hereinbefore.

FIG. 2b shows a representative end view of the new modified cathode design of FIG. 2a in accordance with the principles of the present invention. The flat surface is shown as a rounded edge that is coaxial with the surrounding dome-shaped portion of the cathode tip. FIG. 2c is a representative perspective view of the new modified cathode design of FIGS. 2a and 2b in accordance with the principles of the present invention. The cathode tip includes the partially dome shaped portion and the fault surface, both of which is solid. To be clear, the flat surface is not a protrusion that extends out from the dome shaped portion. Rather, the dome shape rounded edges terminate onto the flat surface, which is preferably fabricated by removing a predetermined amount of material from a fully dome shaped cathode tip.

The partially dome shaped cathode tip is further characterized by a degree of curvature as indicated by the arrow in FIG. 2a designated by the label “Dome”. Any suitable radius of curvature is contemplated by the present invention to stabilize the arc attachment along the cathode flat surface. In one example, the degree of curvature can range from 0.1 inches to about 0.5 inches and more preferably from 0.2 inches to about 0.4 inches.

The new cathode design distributes heat noticeably better by virtue of uniform rotational movement of the arc in comparison to that described with the conventional cathode design of FIG. 1. The stable arc rotational movement is believed to be achieved, at least in part, by the end portion of the arc remaining attached to the cathode tip along the centerline of the flat surface, whereby the centerline or midpoint of the flat surface is that point through which the central longitudinal axis traverses, during the coating operation. In other words, the arc end along the cathode tip remains attached to the flat surface along the centerline or midpoint of the flat surface. Contrary to the fully rounded cathode tip of FIG. 1, the new modified cathode tip is able to prevent the arc from randomly moving along the cathode tip surface. As a result, the present invention allows the arc to more freely rotate inside the anode inner surface while the cathode end of the arc is substantially fixed along the centerline of the flat surface. Such stable arc attachment at the cathode tip causes the arc to more freely rotate within the anode passageway. The free rotation avoids the arc becoming biased into one position or even becoming stationary in the gap between the cathode tip and anode inner surface. The more uniform rotational movement of the arc creates more uniform heat distribution, in comparison to the design of FIG. 1, which reduces or eliminates the chance for heat to build-up in the anode and at the cathode tip, thereby minimizing or eliminating anode and cathode surface defects and allowing the cathode and anode to operate at elevated enthalpy and power levels.

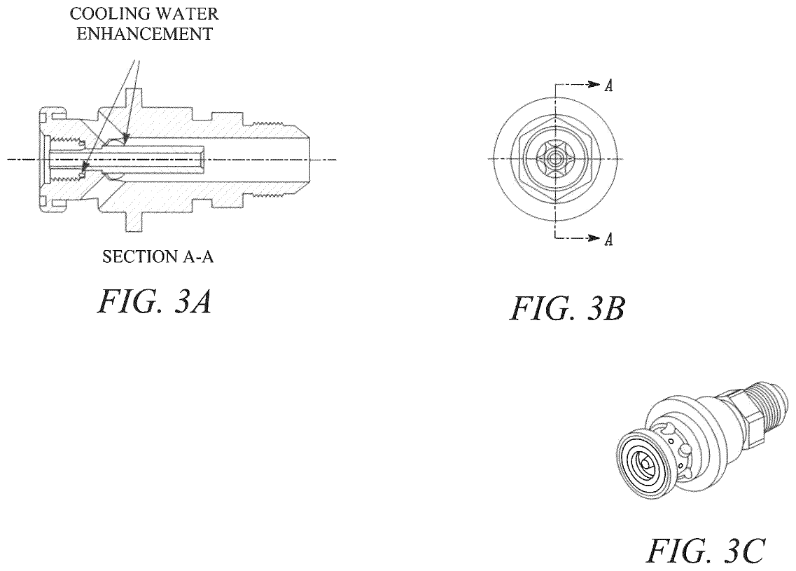

In addition to the new modified cathode device, a modified cathode holder is provided into which the cathode device is loaded. FIGS. 3a, 3b and 3c show a cross sectional, end view and perspective, respectively, of the new modified cathode holder. FIG. 3a shows a cross-sectional view into which the cathode device of FIGS. 2a, 2b and 2c is designed to be loaded. The end of the holder shown in FIG. 3c that is visible represents the portion into which the new modified cathode device can be threaded. FIG. 3a shows a cooling water enhancement. The cooling water enhancement includes multiple tubular-like passages extending in a circumferential arrangement as shown in FIG. 3b. The cooling water enhancement extends in a longitudinal direction as shown in FIG. 3a, and receives cooling water from the rear portion of the cathode holder and plasma arc spray gun, as will be explained below. The cooling water enhancement is configured to be in direct contact with an end of the modified cathode device, thereby improving the ability to dissipate heat away from the cathode device during spray operation, which allows usage of the present invention at higher enthalpies and power levels than previously possible using the device, holder and plasma arc spray gun of FIG. 1. With regards to the standard plasma arc spray gun of FIG. 1, the cathode holder is not configured to allow direct contact with the water.

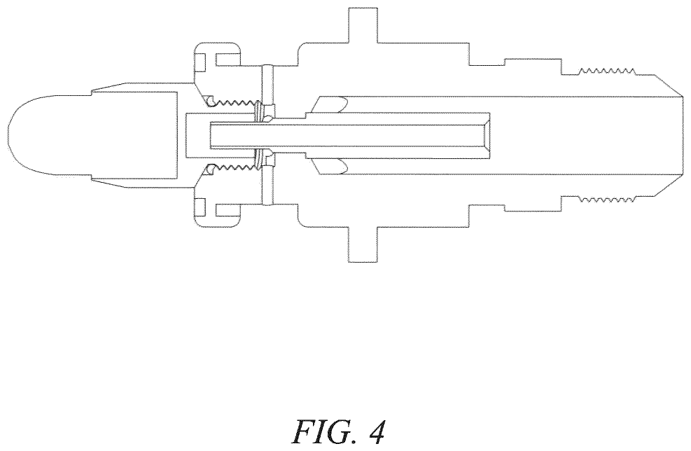

FIG. 4 shows the cathode device of FIGS. 2a, 2b and 2c connected into the cathode holder of FIGS. 3a, 3b and 3c to create an improved cathode assembly. Preferably, and as can been in FIG. 3a, the cathode holder includes a projection that threads into the cathode. However, any other suitable means for connecting the cathode into the cathode holder is contemplated. FIG. 4 shows that the partially dome shaped portion is located external to the cathode holder. Each of the modified cathode device and the cathode holder is coaxial with a central longitudinal axis that traverses the improved cathode assembly. The cooling water enters the multiple tubular-like passages of cooling water enhancement during operation of the plasma arc spray gun.

The new geometry of the cathode tip itself beneficially allows (1) centering of one end of the arc along the flat surface; (2) thereby allowing operation of the plasma arc spray gun at higher enthalpy and power levels. Additionally, the incorporation of the cooling water enhancement structure inside the modified cathode holder further increases cooling efficiency of the cathode surfaces including the cathode tip, which allows operation of the cathode at even higher enthalpy and power levels.

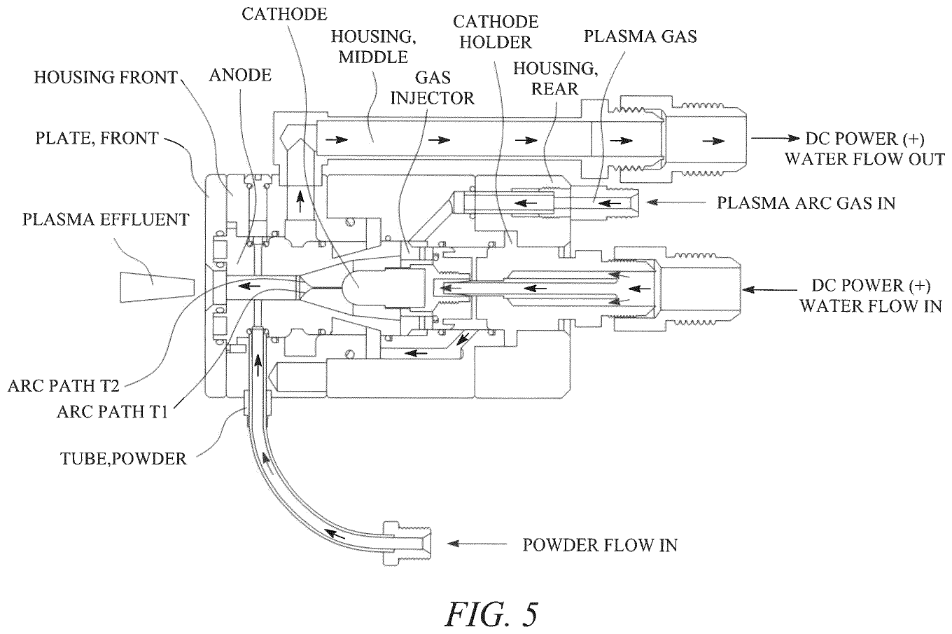

FIG. 5 shows an improved plasma arc spray gun, which incorporates the modified cathode device loaded into the modified cathode holder. The anode and new, modified cathode cooperate with each other to define an annular flow chamber for the flow of plasma arc gas therebetween, as can be seen by the labelling “Plasma Arc Gas In” and corresponding arrows. Cooling water is introduced into the rear portion of the gun as designated by the label “DC Power (−) Water Flow In”. The cooling water enters into the cooling enhancement of the modified cathode holder and comes into direct contact with the cathode device, and then flows out as indicated by the arrows and designated by the label “DC Power (+) Water Flow Out”. A voltage potential is created between the positive lead and the negative lead shown in FIG. 5 and then an arc is generated to bridge the gap therebetween. The rotational movement of the arc is shown in FIG. 5 and designated as “arc path”. One end of the arc is attached along the cathode tip at the centerline of the flat surface thereof, the details of which have been shown and discussed in FIGS. 2a, 2b and 2c. The other end of the arc extends towards the anode inner surface, as shown in FIG. 5. The flat surface along the partially dome shaped portion of the cathode tip causes the end of the arc to remain attached along the centerline of the flat surface, as clearly seen in FIG. 5. Applicants surprisingly discovered that the flat surface prevents the arc from wandering off the cathode centerline surface in the manner shown in FIG. 1, and, instead, the end portion of the arc at the cathode tip remains substantially fixed at centerline of the flat surface as shown in FIG. 5. The Applicants during their testing had expected the arc to move to the edges of the flat surface, because such locations represent the path of least resistance and shortest distance between the anode and cathode. However, for reasons not entirely understood, the arc point of attachment was observed to be along the centerline of the flat surface of the cathode, and remain at such location during operation of the plasma arc spray gun.

By positioning one end of the arc along the centerline of the flat surface of the cathode, through which a central longitudinal axis traverses, the rotational movement of the arc is substantially more uniform in comparison to that of FIG. 1. In other words, the end of the arc along the anode inner surface rotates therein while the end of the arc along the centerline of the cathode tip flat surface remains attached to the cathode center point. In this manner, a more stable plasma is produced, and component life of the cathode surface is extended, whereby there is a reduction or elimination of surface defects on the cathode surfaces. Additionally, because the end points of the arc do not shorten during rotational movement, the arc length is not susceptible to large changes in comparison to the erratic arc movement of FIG. 1. A substantially constant arc length translates into more uniform voltage and power conveyed into the plasma spray process and higher stability of the arc.

Having generated the arc, cooling water is introduced into the enhancement feature of the modified cathode holder; plasma gas is introduced into the rear housing and gas injector as shown in FIG. 5; and powder is introduced into the housing front of the plasma arc spray gun as shown in FIG. 5. The steps can occur in any sequence without departing from the scope of the present invention. The plasma gas flows around the cathode tip and contacts the hot arc, which is rotating along the inner surface of the anode and remaining substantially fixed and attached to the centerline flat surface of the cathode. The plasma gas absorbs heat from the arc and increases in temperature. The powder is introduced into the front of the plasma gun, where it contacts the hot plasma gas, thereby increasing in temperature and becoming molten. The molten powder and hot plasma gas exit the front of plasma gun as a plasma effluent, as designated in FIG. 5, and then the molten powder can be deposited onto a substrate. By virtue of substantially uniform arc movement and the cooling water directly contacting the cathode, the cathode does not incur significant surface defects. As such, the present invention creates a more stable process than previously attainable with the apparatus of FIG. 1.

Several experiments were performed to compare the present invention with conventional designs. While preferred embodiments of the present invention have been set forth above, the following examples are intended to provided a basis for comparison of the present invention with other conventional designs, but they are not to be construed as limiting the invention.

### Comparative Example 1

A fully dome shaped cathode device with a longitudinal tapered section as shown in FIG. 1 was placed in a standard cathode holder to create a standard cathode assembly. To be clear, the fully dome shaped cathode device did not have a flat surface along the cathode tip. The standard cathode assembly was incorporated into a plasma spray arc gun as shown in FIG. 1. Twelve runs were employed using the plasma arc spray gun with power levels ranging from 50-70 volts.

Applicants observed damage to the cathode tip as a result of overheating. Applicants concluded that the fully dome shaped cathode design was not capable of handling the higher heat loads, especially at the higher voltages.

### Comparative Example 2

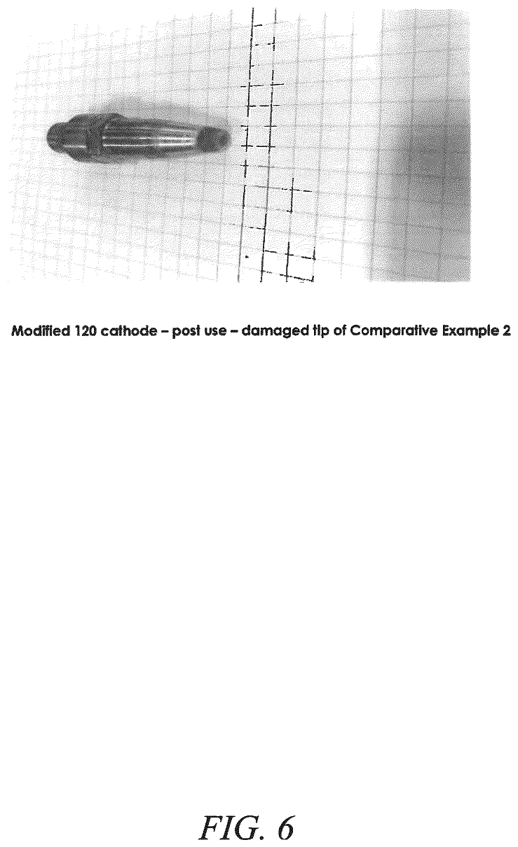

Next, a fully dome shaped cathode device with a longitudinal tapered section as shown in FIG. 1 was placed in a modified cathode holder with a cooling enhancement feature as shown FIGS. 3a, 3b and 3c. To be clear, the fully dome shaped cathode device did not have a flat surface along the cathode tip. The cathode assembly was incorporated into a standard arc spray gun. With the exception of the cooling enhancement feature, the plasma arc spray gun was similar to that shown in FIG. 1. Nine runs were employed using the plasma arc spray gun with power levels that ranged from 50-70 volts. Applicants observed damage to the cathode tip. Specifically, FIG. 6 shows a photograph of a damaged cathode tip that exhibited cracking and a flawed surface that was subject to overheating. The cathode tip had a fully dome shaped portion with no flat surface; Applicants observed on the inner surface of the anode a bright orange discoloration, which indicated that the arc was attaching at a single location therealong as opposed to rotationally moving about the anode inner surface. The arc failed to release from that particular location along the anode inner surface.

### Comparative Example 3

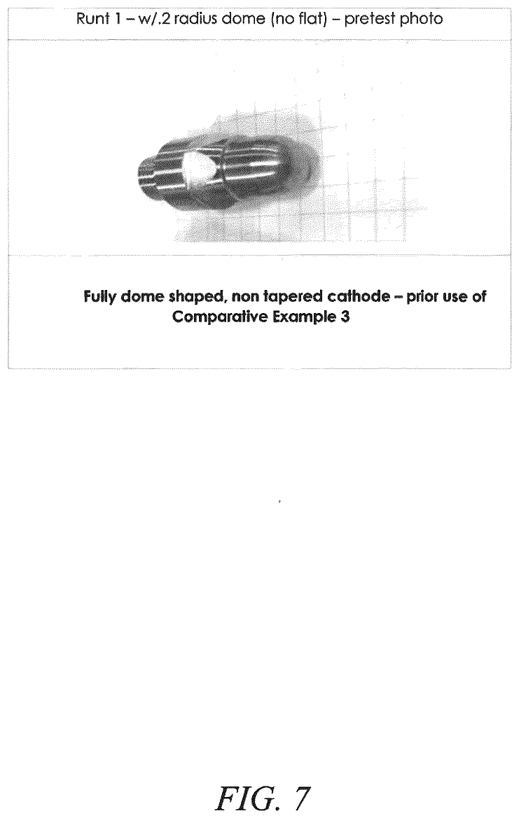

Next, a fully dome shaped cathode device without a longitudinal tapered section as was evaluated in Comparative Examples 1 and 2 was evaluated in this test. To be clear, the fully dome shaped cathode device did not have a flat surface along the cathode tip and did not possess a longitudinal tapered section. FIG. 7 shows a photograph of the cathode design prior to its test. The cathode design of FIG. 7 was incorporated into a plasma spray arc gun. Eight runs were employed using the plasma arc spray gun with power levels that ranged from 50-70 volts. Applicants observed that the (1) arc was not rotating freely inside the anode inner surface and exhibited a single point of attachment therealong; and (2) the arc attachment along the cathode tip was not on the centerline of the cathode tip. The undesirable features of (1) and (2) led the Applicants to conclude that the cathode design of FIG. 7 was not acceptable because the tendency for this cathode design to create an arc with a single point attachment would eventually cause damage to the cathode tip.

### Example 1 (Invention)

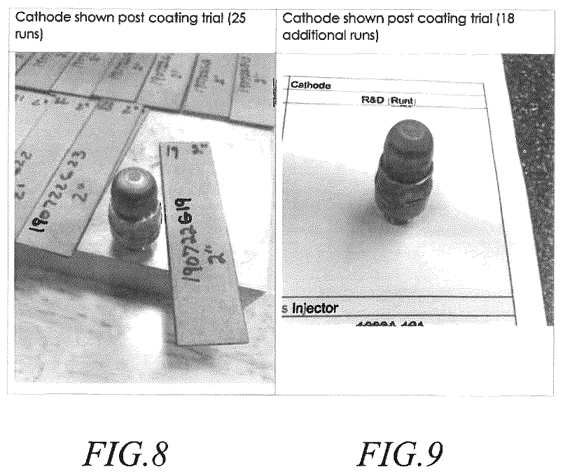

After performing the tests described in connection with Comparative Examples 1, 2 and 3, the Applicants evaluated the design of FIG. 8, which represented a cathode having a partially dome shaped tip with a flat surface. Forty seven runs were employed using the cathode design of FIG. 8 at power levels ranging between 50-70 volts. Applicants observed that the end of the arc remained attached to the centerline of the flat surface of the cathode tip while the other end of the arc was capable of freely rotating about the inner surface of the anode in a more uniform manner than observed in Comparative Examples 1, 2 and 3. No single points of attachment along the anode inner surface were observed during the runs.

The above experiments validated that the ability for the arc to rotate freely along the anode inner surface was dependent upon the end portion of the arc on the cathode remaining attached to the centerline of the cathode along a flat surface.

The present invention offers a viable approach for using a new cathode tip design in combination with a new cathode holder perform plasma arc spraying with alternative gases (e.g., nitrogen, hydrogen and the like) which can create higher operating temperatures of the various components of the gun including the cathode.

While it has been shown and described what is considered to be certain embodiments of the invention, it will, of course, be understood that various modifications and changes in form or detail can readily be made without departing from the spirit and scope of the invention. It is, therefore, intended that this invention is not limited to the exact form and detail herein shown and described, nor to anything less than the whole of the invention herein disclosed and hereinafter claimed.

1. A modified cathode device adapted for use in a plasma arc spray gun, said modified cathode device comprising:
a central longitudinal axis traversing the modified cathode device from a first end to a second end;
a partially dome-shaped portion, said partially dome-shaped portion having rounded edges, said rounded edges terminating as a flat surface along the first end of the modified cathode device, said flat surface characterized by a width extending from a first edge of the flat surface to a second edge of the flat surface and a midpoint located between the first edge and the second edge, wherein the midpoint of the flat surface is located along the central longitudinal axis of the modified cathode device; and
a body portion extending from the partially dome-shaped body portion to the second end of the modified cathode device.

2. The modified cathode device of claim 1, wherein said flat surface is sufficient to stabilize an arc along a central portion between the first edge and the second edge of the flat surface.

3. The modified cathode device of claim 1, wherein the rounded edges have a degree of curvature represented by a radius of 0.1 inches to 0.3 inches.

4. The modified cathode device of claim 1 wherein the second end of the body portion is configured to be operably connected to a cathode holder.

5. An improved cathode assembly for use in a plasma arc spray gun, comprising:
a modified cathode device having a partially dome-shaped portion along a first end and a body portion extending from the partially dome-shaped portion to a second end of the modified cathode device,
a cathode holder having an inner surface configured for receiving the body portion of the modified cathode device at the second end thereof, said cathode holder comprising a cooling water enhancement, said cooling water enhancement configured to be in direct contact with the second end of the body portion of the modified cathode device;
wherein the partially dome-shaped portion is located external to the cathode holder; and further wherein each of the modified cathode device and the cathode holder is coaxial with a central longitudinal axis that traverses the improved cathode assembly.

6. The improved cathode assembly of claim 5, wherein the cooling water enhancement is a tubular-like structure, said tubular-like structure extending along a portion of the central longitudinal axis within a passageway of the cathode holder.

7. The improved cathode assembly of claim 5, wherein the cooling water enhancement is a tubular-like structure having multiple holes adapted to receiving cooling water therein, said multiple holes extending in a circumferential arrangement within the tubular-like structure.

8. The improved cathode assembly of claim 5, wherein the second end of the body portion of the modified cathode device is operably connected into the cathode holder.

9. The improved cathode assembly of claim 5, wherein said partially dome-shaped portion has rounded edges, said rounded edges terminating as a flat surface along the first end of the modified cathode device, said flat surface characterized by a width extending from a first edge of the flat surface to a second edge of the flat surface and a midpoint located between the first edge and the second edge, wherein the midpoint of the flat surface is located along the central longitudinal axis of the modified cathode device.

10. An improved plasma arc spray gun, comprising:
a modified cathode device having a partially dome-shaped portion along a first end and a body portion extending from the partially dome-shaped portion to a second end of the modified cathode device,
a cathode holder having an inner surface operably connected to the body portion of the modified cathode device at the second end thereof to form an improved cathode assembly, said cathode holder comprising a cooling water enhancement, said cooling water enhancement configured to be in direct contact with the second end of the body portion of the modified cathode device;
wherein the partially dome-shaped portion is located external to the cathode holder;
an anode having an exterior and an interior, the anode interior defined by a first interior segment, a second interior segment, and a third interior segment, the first interior segment in fluid communication with a powder injection pathway, the second interior segment containing the modified cathode device and the third interior section containing the cooling water enhancement of the cathode holder;
wherein the improved cathode assembly and the anode are coaxial with a with a central longitudinal axis that traverses the improved plasma arc spray gun.

11. The improved plasma arc spray gun of claim 10, wherein the partially dome-shaped portion has rounded edges, said rounded edges terminating as a flat surface along the first end of the modified cathode device, said flat surface characterized by a width extending from a first edge of the flat surface to a second edge of the flat surface and a midpoint located between the first edge and the second edge, wherein the midpoint of the flat surface is located along the central longitudinal axis of the modified cathode device.
